(19) United States
(12) Patent Application Publication
(10) Pub. No.: US 2025/0054677 A1
(43) Pub. Date: Feb. 13, 2025

(54) COIL DEVICE

(71) Applicant: TDK Corporation, Tokyo (JP)

(72) Inventors: Masayuki NAGATA, Tokyo (JP); Toshiyuki HORIKAWA, Tokyo (JP); Masaaki IWAKURA, Tokyo (JP); Tomohiro FURUICHI, Tokyo (JP); Kaito TANIZAKI, Tokyo (JP)

(73) Assignee: TDK Corporation, Tokyo (JP)

(21) Appl. No.: 18/794,700

(22) Filed: Aug. 5, 2024

(30) Foreign Application Priority Data
Aug. 10, 2023 (JP) 2023-131084
Nov. 1, 2023 (JP) 2023-187983

(51) Int. Cl. H01F 27/24; H01F 27/08; H01F 27/28

(52) U.S. Cl. CPC H01F 27/24; H01F 27/08; H01F 27/2823

(57) ABSTRACT

A coil device includes a core containing a magnetic material and a wire disposed in a coil shape around at least a part of the core. 70% or more of a volume of a middle leg portion of the core is located below a venting surface of a heat-dissipating resin. Between a first base portion of the core and one end of the middle leg portion is an air layer. The air layer is located below the venting surface of the heat-dissipating resin.

### TECHNICAL FIELD

The present invention relates to a coil device that can be suitably used as, for example, a transformer.

### BACKGROUND

To improve heat resistance of a coil device, its core is partly immersed in a heat-dissipating resin for enhanced cooling effects as in, for example, Patent Document 1. Unfortunately, because not much of the core is covered with the heat-dissipating resin in this technique, sufficient heat dissipation effects cannot be expected.

In this regard, a large portion of the core may be covered with the heat-dissipating resin; however, in such a structure, a case storing the heat-dissipating resin has too large a size, contrary to requests for reduction in size of the coil device. In this respect, the core may be covered with the heat-dissipating resin so that a winding portion of a wire is immersed in the heat-dissipating resin to the minimum extent necessary.

In general, a middle leg portion, around which the winding portion of the wire is disposed, of the core is integrally connected to a base portion of the core; and heat generated at the middle leg portion is transferred to the base portion of the core and is dissipated to a cooling portion, in contact with the base portion, of the case. Thus, at the middle leg portion in particular, a rapid temperature gradient is generated along a winding axis of the wire; and at the core, thermal stress is generated. This readily causes worse core losses. In particular, along with an increase in currents of the coil device in recent years, reduction of thermal stress generated at the core has been a challenge.
Patent Document 1: JP Patent Application Laid Open No. 2014-36194

### SUMMARY

The present invention has been achieved in view of such circumstances. It is an object of the invention to provide a coil device capable of having reduced thermal stress generated at a core.

To achieve the above object, a coil device according to the present invention is a coil device including:
a core including a magnetic material; and
a wire disposed in a coil shape around at least a part of the core,
wherein
the core includes a middle leg portion and a first base portion;
the middle leg portion has a winding portion of the wire disposed therearound;
the first base portion is disposed at or near one end of the middle leg portion along a winding axis of the winding portion;
70% or more, preferably 80% or more, more preferably 90% or more, or still more preferably 95% or more of a volume of the middle leg portion is located below a venting surface of a heat-dissipating resin;
between the first base portion and the one end of the middle leg portion is an air layer; and
the air layer is located below the venting surface of the heat-dissipating resin.

In this coil device, because most of the volume of the middle leg portion is located below the venting surface of the heat-dissipating resin, most of the volume of the winding portion, disposed around the middle leg portion, of the wire as well as the middle leg portion is cooled by the heat-dissipating resin. This improves heat-dissipating ability. Moreover, because between the first base portion and the one end of the middle leg portion is the air layer, heat of the middle leg portion is less readily transferred to the first base portion, reducing variance in temperature distribution of the middle leg portion along the winding axis. The middle leg portion is evenly cooled by the heat-dissipating resin. Consequently, at the middle leg portion, a rapid temperature gradient is less readily generated along the winding axis of the wire; and thermal stress generated at the core is reduced. This reduces core losses.

At least either a surface of the first base portion or a surface of the one end of the middle leg portion may have fine irregularities at which the first base portion and the one end of the middle leg portion are partly in contact; and the air layer may be in a depression of the fine irregularities.

That is, it may be that the one end of the middle leg portion only abuts the surface of the first base portion; and provided that at least either the surface of the first base portion or the surface of the one end of the middle leg portion abutting each other has the fine irregularities, the air layer having a space corresponding to surface roughness of the fine irregularities is provided in the depression of the fine irregularities.

In this situation, a lower limit of a thickness of the air layer along the winding axis is determined depending on the surface roughness or the like of the fine irregularities and is not limited; and the lower limit is preferably, for example, 5 μm or more, 8 μm or more, 10 μm or more, or 12 μm or more. An upper limit of the thickness of the air layer along the winding axis is determined so that it is difficult for the heat-dissipating resin in a fluid state to get in between the first base portion and the one end of the middle leg portion abutting each other and is not limited; and the upper limit is preferably, for example, 50 μm or less, 40 μm or less, 30 μm or less, 20 μm or less, or 15 μm or less.

Provided that at least either the surface of the first base portion or the surface of the one end of the middle leg portion abutting each other has the fine irregularities, only placing the one end of the middle leg portion on the surface of the first base portion can easily provide the air layer having the thickness within such a range. With the air layer having the thickness within such a range, it is difficult for the heat-dissipating resin in a fluid state to get in between the abutting surfaces of the first base portion and the one end of the middle leg portion, and the air layer having the predetermined thickness is maintained. Note that the heat-dissipating resin may slightly enter a part of the air layer.

A sealing member may be attached to a circumference of the one end of the middle leg portion. The sealing member solely or a combination of the sealing member and an other member may provide the air layer having a predetermined distance between the first base portion and the one end of the middle leg portion, thereby preventing the heat-dissipating resin from entering the air layer.

With such a structure, the sealing member (or the sealing member and the other member) effectively prevents the heat-dissipating resin in a fluid state around the sealing member (or the sealing member and the other member) from entering the air layer, maintaining the air layer having the predetermined thickness.

A tubular portion of a bobbin may be disposed between the middle leg portion and the winding portion of the wire. The other member may include an inward protrusion at one end of the tubular portion of the bobbin; and the sealing member may be disposed between the inward protrusion and the one end of the middle leg portion.

With such a structure, the sealing member and the inward protrusion of the bobbin effectively prevent the heat-dissipating resin in a fluid state around the sealing member and the inward protrusion from entering the air layer, maintaining the air layer having the predetermined thickness.

The sealing member may include an O-ring. The other member may include a spacer having a ring shape and adhering to a surface of the first base portion; and the O-ring may be held around the circumference of the one end of the middle leg portion and be disposed on the spacer.

With such a structure, the sealing member and the spacer effectively prevent the heat-dissipating resin in a fluid state around the spacer and the sealing member from entering the air layer even without a bobbin, maintaining the air layer having the predetermined thickness.

Note that, in a situation where the sealing member is used, the heat-dissipating resin may slightly enter a part of the air layer. Also, a resin layer other than the air layer may be provided in between the first base portion and the one end of the middle leg portion.

In a situation where the sealing member is used, the upper limit of the thickness of the air layer along the winding axis is not limited and is determined according to leakage properties or the like required for a coil device. The upper limit is preferably 3 mm or less, more preferably 2 mm or less, or still more preferably 1 mm or less. The lower limit of the thickness of the air layer along the winding axis is determined so that the amount of heat transfer from the one end of the middle leg portion to the surface of the first base portion is smaller than the amount in a situation where no air layer is provided. The lower limit is preferably, for example, 5 μm or more, 8 μm or more, 10 μm or more, or 12 μm or more.

The core may further include a second base portion provided continuously at an other end of the middle leg portion along the winding axis. Alternatively, the core may further include a second base portion disposed apart by a predetermined distance from the other end of the middle leg portion along the winding axis.

Between the second base portion and the other end of the middle leg portion may be an air layer having a thickness of preferably 2 mm or less or more preferably 1.9 mm or less. This air layer between the second base portion and the other end of the middle leg portion makes it difficult for stress (e.g., thermal expansion force) generated at the middle leg portion to be transferred to the second base portion, allowing reduction of thermal stress that may be generated at the second base portion.

The first base portion may be close to a cooling wall surface of a case filled with the heat-dissipating resin. In such a situation, particularly the first base portion is cooled to readily produce temperature difference; however, because the air layer is provided between the one end of the middle leg portion and the first base portion, unevenness of temperature distribution of the middle leg portion along the winding axis can be improved.

In a situation where the cooling wall surface of the case is a bottom surface of the case, the core is accommodated in the case so that the winding axis of the winding portion of the wire is substantially perpendicular to the bottom surface of the case. In a situation where the cooling wall surface of the case is a side surface of the case, the core is accommodated in the case so that the winding axis of the winding portion of the wire is substantially parallel to the bottom surface of the case. With such a structure, heat-dissipation ability of the middle leg portion and the winding portion, disposed around the middle leg portion, of the wire is improved.

The other end of the middle leg portion may be located below the venting surface of the heat-dissipating resin. With such a structure, the heat-dissipation ability of the middle leg portion and the winding portion, disposed around the middle leg portion, of the wire is improved.

The other end of the middle leg portion may be located above the venting surface of the heat-dissipating resin. With such a structure, the air layer is readily provided between the second base portion and the other end of the middle leg portion.

Preferably, the heat-dissipating resin is disposed at a location such that the heat-dissipating resin covers the winding portion disposed around the middle leg portion. With such a structure, the heat-dissipation ability is improved.

The coil device may further include a terminal block holding a lead portion of the wire. The terminal block may be attached to the bobbin, the case accommodating the heat-dissipating resin, or the second base portion disposed at or near the other end of the middle leg portion along the winding axis.

### BRIEF DESCRIPTION OF THE DRAWING(S)

FIG. 1A is a schematic perspective view of a coil device according to an embodiment of the present invention.

FIG. 1B is a schematic perspective view of a coil device according to another embodiment of the present invention.

FIG. 2A is a schematic exploded perspective view of the coil device shown in FIG. 1A.

FIG. 2B is a schematic exploded perspective view of the coil device shown in FIG. 1B.

FIG. 3A1 is a sectional schematic perspective view along line IIIA-IIIA in FIG. 1A.

FIG. 3A2 is a sectional schematic view along line IIIA-IIIA in FIG. 1A.

FIG. 3B1 is a sectional schematic perspective view along line IIIB-IIIB in FIG. 1B.

FIG. 3B2 is a sectional schematic view along line IIIB-IIIB in FIG. 1B.

FIG. 4A is a sectional schematic view of only a core shown in FIG. 3A2.

FIG. 4B is a sectional schematic view of a modified example of the core shown in FIG. 4A.

FIG. 4C is a sectional schematic view of another modified example of the core shown in FIG. 4A.

FIG. 4D is a sectional schematic view of still another modified example of the core shown in FIG. 4A.

FIG. 4E is a sectional schematic view of still another modified example of the core shown in FIG. 4A.

### DETAILED DESCRIPTION

Hereinafter, embodiments of the present invention are described with reference to the drawings. Illustrations in the drawings are only schematically and exemplarily provided for understanding of the present invention; and the illustrated appearance, dimensional ratios, etc. may be different from actual ones. The present invention is not limited to the following embodiments.

### First Embodiment

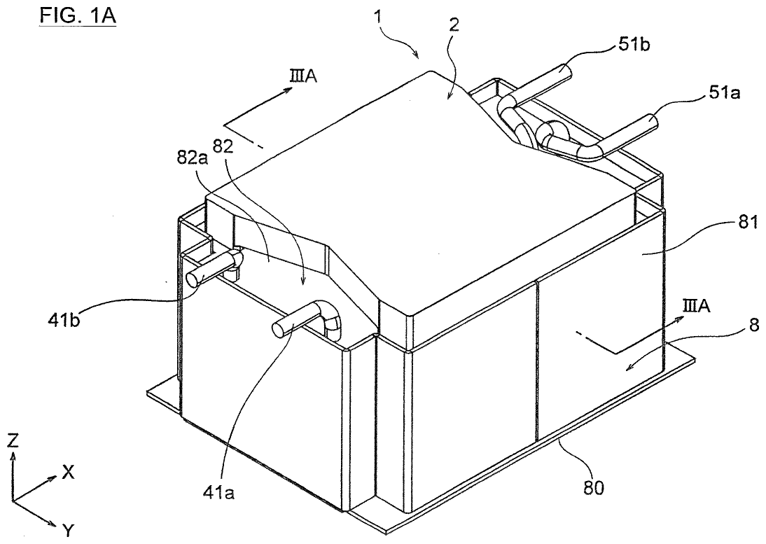

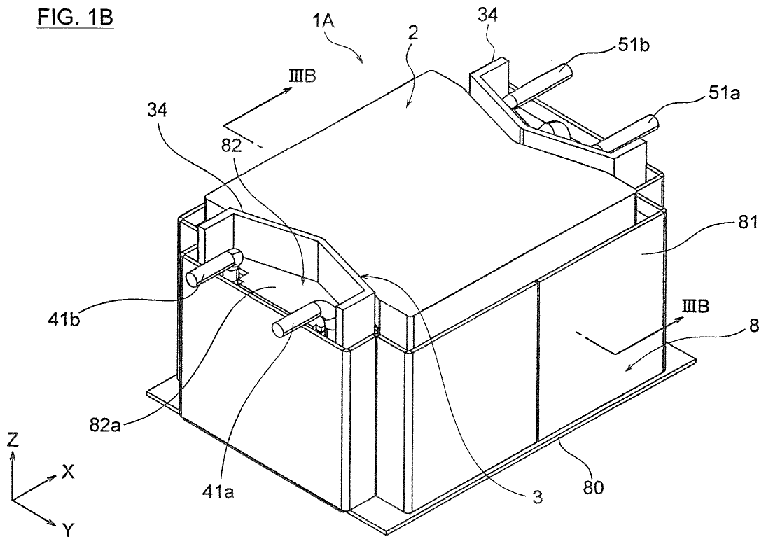

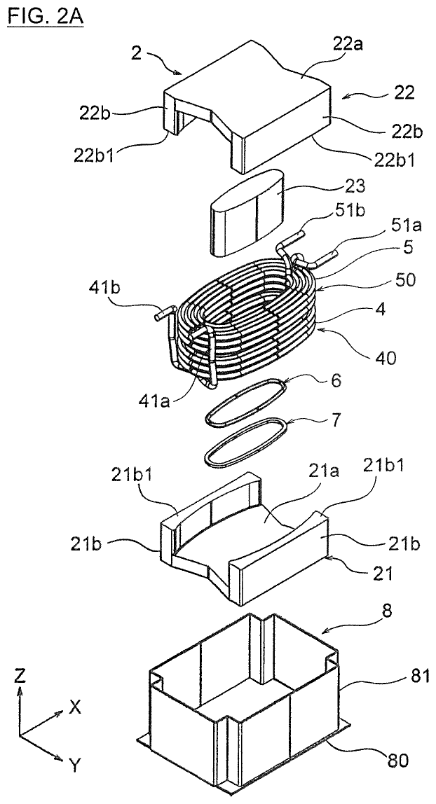

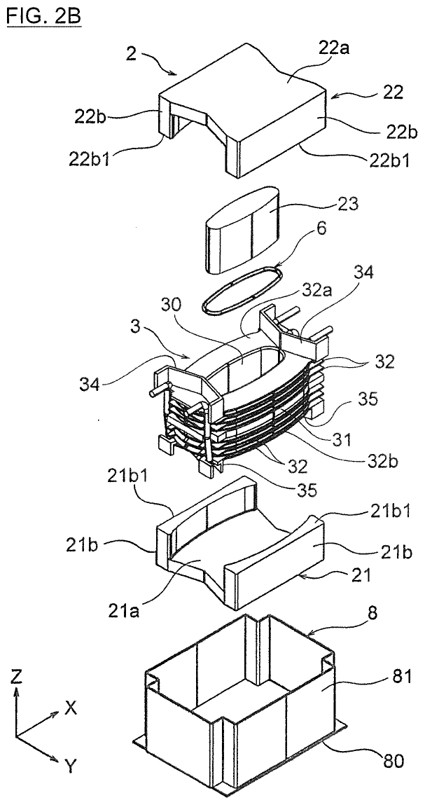

A coil device 1 according to an embodiment of the present invention shown in FIG. 1A functions as, for example, a leakage transformer and is included in an on-board charger, a power supply circuit of various electronic equipment, etc. As shown in FIG. 2A, the coil device 1 includes a core 2, a first wire winding portion 40 of a first wire 4, a second wire winding portion 50 of a second wire 5, and a case 8.

In the drawings, the X-axis, the Y-axis, and the Z-axis are mutually perpendicular; and the Z-axis is parallel to a height direction of the coil device 1. In the following description, with regard to the X-axis, the Y-axis, and the Z-axis, a direction towards a center of the coil device 1 is referred to as an inward direction, and a direction away from the center of the coil device 1 is referred to as an outward direction.

As shown in FIG. 2A, in the present embodiment, the core 2 includes a first core 21, a second core 22, and a middle leg portion 23. The first core 21 is disposed below the second core 22 along the Z-axis. The second core 22 is disposed above the first core 21 along the Z-axis. The middle leg portion 23 is disposed between the first core 21 and the second core 22. The first core 21, the second core 22, and the middle leg portion 23 are formed separately.

The first core 21 includes a first base portion 21a having a flat shape and side leg portions 21b and 21b protruding upwards along the Z-axis from both sides of the first base portion 21a in the Y-axis direction. The second core 22 includes a second base portion 22a having a flat shape and side leg portions 22b and 22b protruding downwards along the Z-axis from both sides of the second base portion 22a in the Y-axis direction.

In the present embodiment, the first core 21 and the second core 22 are each a U-shaped core having a substantially U-shape in its section parallel to a plane containing the Z-axis and the Y-axis; and the first core 21 and the second core 22 have the same shape but may have different shapes. For example, either the first core 21 or the second core 22 may be a U-shaped core, and the other may be an I-shaped core.

The cores 21 and 22 and the middle leg portion 23 may be any cores containing a magnetic material and may be constituted by, for example, ferrites, metal magnetic materials, or resin containing a magnetic powder.

In the present embodiment, around the middle leg portion 23, the first wire winding portion 40 of the first wire 4 and the second wire winding portion 50 of the second wire 5 are disposed. In the present embodiment, the second wire winding portion 50 is disposed above the first wire winding portion 40 along the Z-axis; however, they may be disposed vice versa. For example, the first wire winding portion 40 is a primary side coil of the transformer, and the second wire winding portion 50 is a secondary side coil of the transformer; however, they may be vice versa.

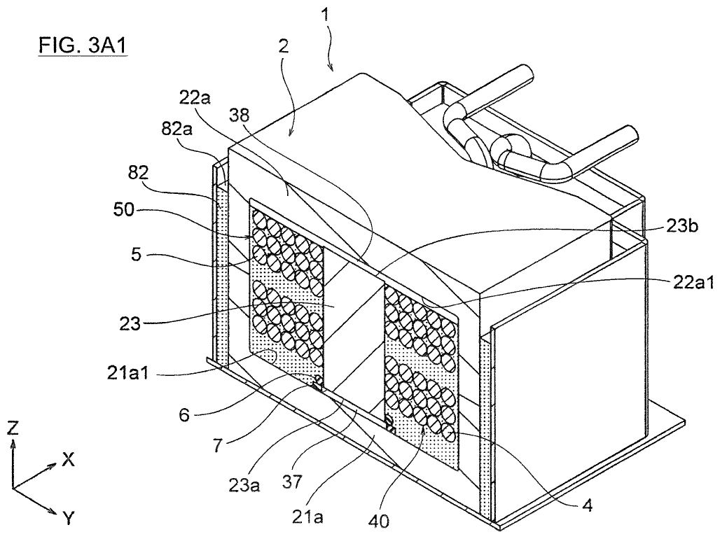

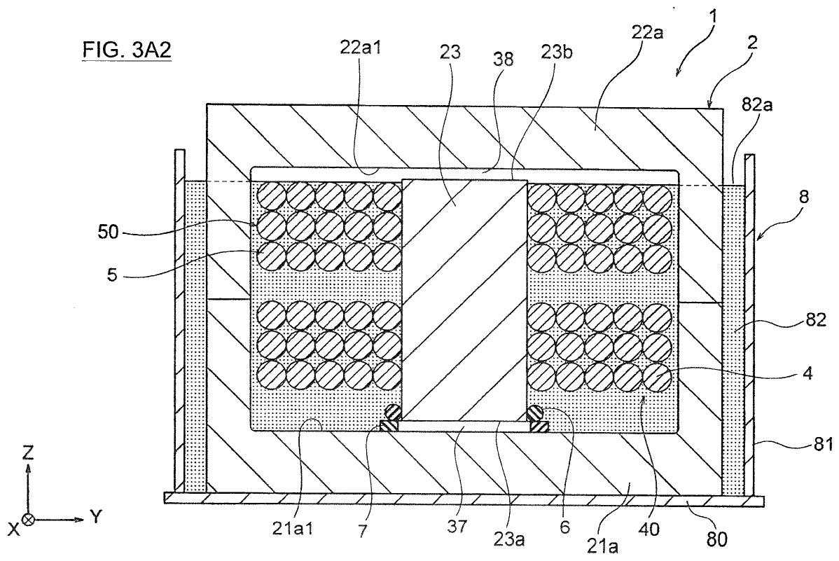

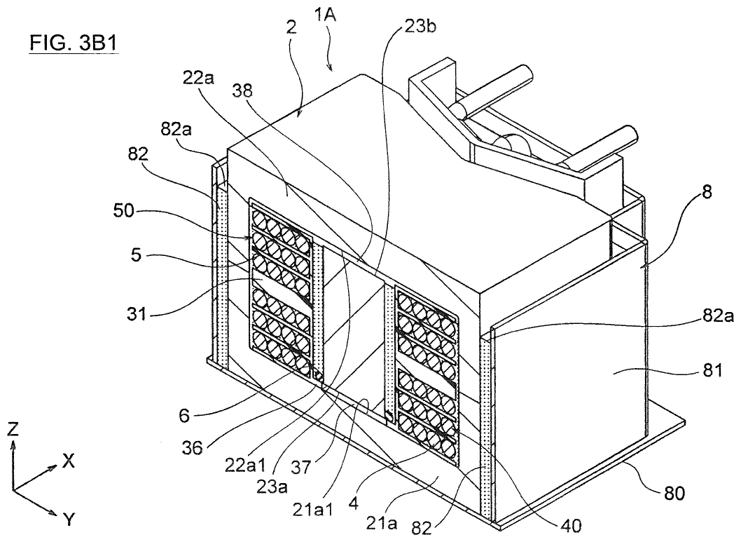

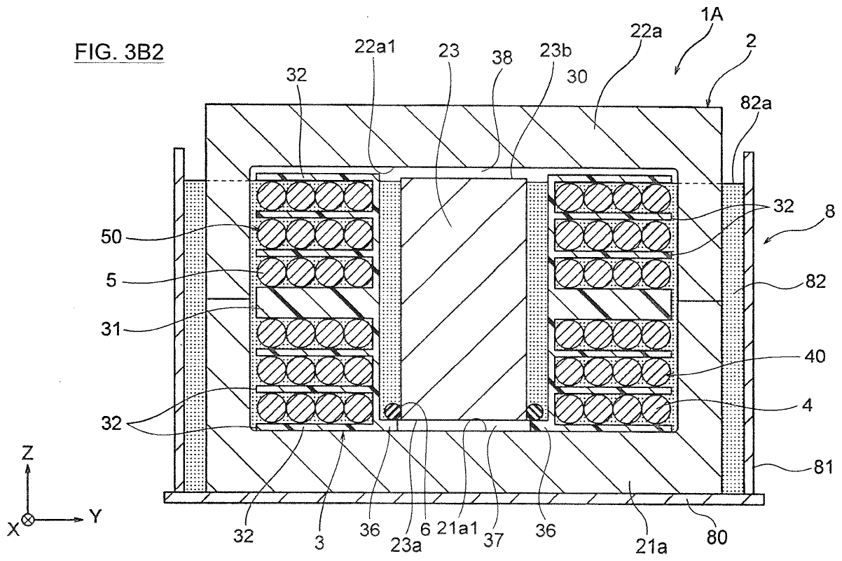

As shown in FIGS. 3A1 and 3A2, the first wire 4 and the second wire 5 may be directly wound around the middle leg portion 23 to form the first wire winding portion 40 and the second wire winding portion 50; however, the first wire winding portion 40 and the second wire winding portion 50 may be prepared as air core coils wound in advance and may then be disposed around the middle leg portion 23. How the wire 4 or 5 is wound is not limited; and it may be, for example, normally wound or a-wound.

In the present embodiment, the first wire 4 and the second wire 5 are each constituted by a conductive wire. It may be that the wire is not insulation coated; however, the wire is preferably insulation coated. The conductive wire may be of any type and may be a conductive core wire (e.g., round wire, rectangular wire, stranded wire, litz wire, or braided wire). A fusing layer or an insulation layer covering the core wire may be made from any material; and examples of such materials include polyurethane, polyamide-imide, polyimide, and polyester.

In the present embodiment, the first wire 4 and the second wire 5 are each constituted by a self-fusing wire; however, either one of the wires may be a self-fusing wire, or both of the wires may be constituted by other wires. At least either the first wire winding portion 40 or the second wire winding portion 50 may be a flat coil. The first wire 4 and the second wire 5 may have the same diameter or different diameters. The diameters are not limited and are preferably, for example, within a range of 1.0 to 3.0 mm.

As shown in FIG. 2A, the first wire 4 constituting the first wire winding portion 40 includes lead portions 41a and 41b at both ends. The respective lead portions 41a and 41b are drawn upwards along the Z-axis from the first wire winding portion 40 and are connected to terminals or the like not shown in the drawings. The second wire 5 constituting the second wire winding portion 50 includes lead portions 51a and 51b at both ends. The respective lead portions 51a and 51b are drawn upwards along the Z-axis from the second wire winding portion 50 and are connected to terminals or the like.

The respective terminals to which these lead portions 41a, 41b, 51a, and 51b are connected may be attached to, for example, terminal blocks not shown in the drawings. The terminal blocks may be attached to an upper surface of the second core 22 of the core 2, to the case 8, or to a bobbin 3 shown in FIG. 2B.

As shown in FIGS. 3A1 and 3A2, in the present embodiment, an O-ring 6 as a sealing member is tightly adhered to a circumference of a lower end 23a of the middle leg portion 23 along the Z-axis. Preferably, a lower end of the O-ring 6 along the Z-axis is substantially flush with the lower end 23a of the middle leg portion 23 along the Z-axis or slightly protrudes below the lower end 23a; however, on the condition that a space 37 described later is provided, the lower end of the O-ring 6 may be located above the lower end 23a.

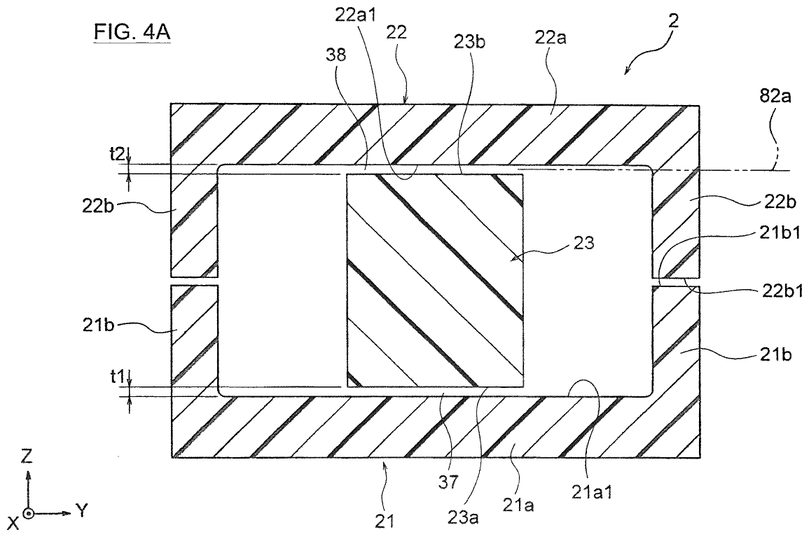

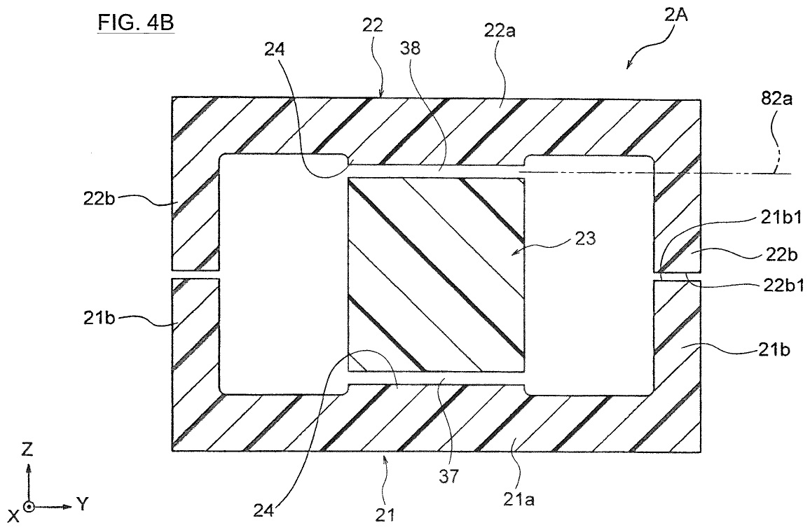

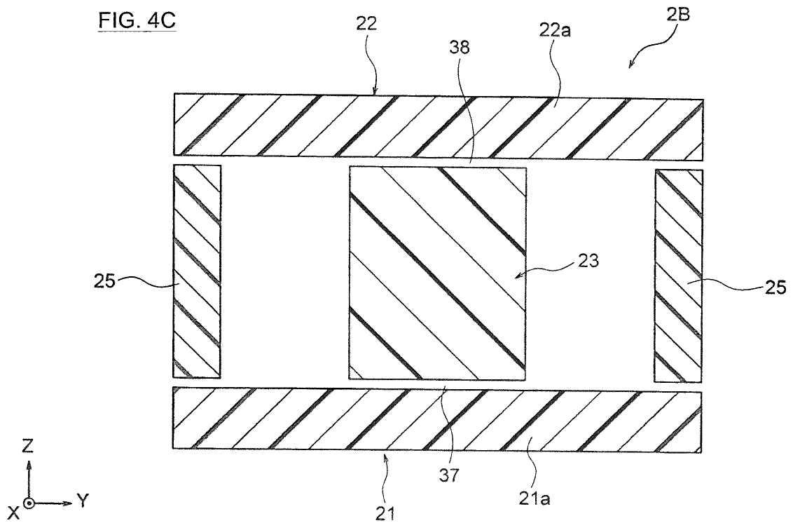

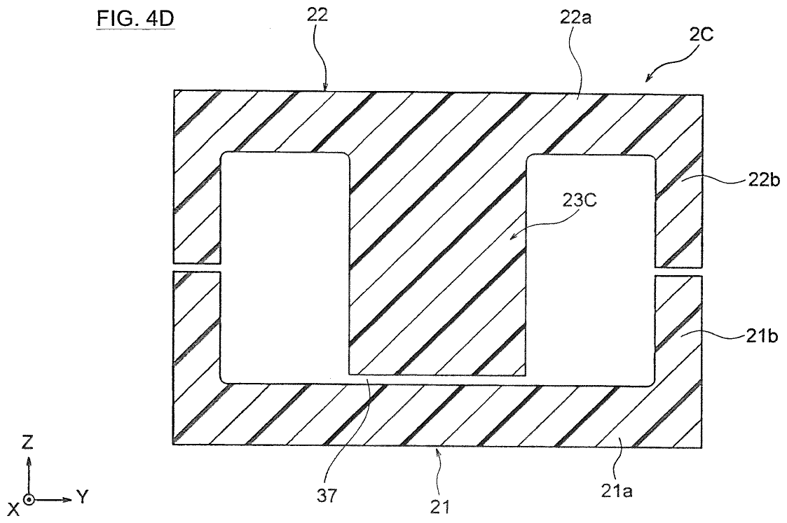

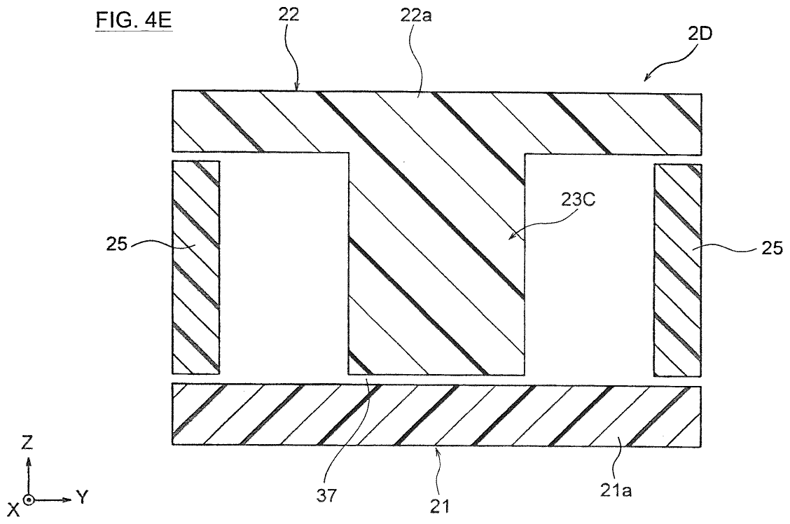

In the present embodiment, below the O-ring 6, a spacer 7 functioning as a part of the sealing member is disposed. The spacer 7 having a rectangular sectional shape is adhered to an inner surface 21al of the first base portion 21a, and the O-ring 6 is adhered to the circumference of the lower end 23a of the middle leg portion 23 and an upper surface of the spacer 7. With such a structure, the space 37 having a predetermined distance (thickness) t1 (see FIG. 4A) is provided between a lower surface of the lower end 23a of the middle leg portion 23 and the inner surface 21al of the first base portion 21a. The space 37 is sealed with the spacer 7 and the O-ring 6. A heat-dissipating resin 82 does not enter the space 37, and an air layer is provided there.

The O-ring 6 is made from any material that can seal a space between the spacer 7 and the circumference of the lower end 23a of the middle leg portion 23. The O-ring 6 is preferably made from, for example, an insulating elastic member (e.g., synthetic resin or rubber). The spacer 7 is made from any material that can adhere to the inner surface 21al of the first base portion 21a and to the O-ring 6. The spacer 7 is preferably made from, for example, an insulating elastic member (e.g., synthetic resin or rubber). In the present embodiment, the spacer 7 is not necessarily attached. For example, it may be that only the O-ring 6 is used to provide the air layer constituting the space 37 having the predetermined distance t1 (see FIG. 4A) between the middle leg portion 23 and the first base portion 21a.

In the present embodiment, the length of the middle leg portion 23 along the Z-axis is determined with respect to the total length of the side leg portions 21b and 22b along the Z-axis so that a space 38 having a predetermined distance (thickness) t2 (see FIG. 4A) is provided between an upper end 23b of the middle leg portion 23 and an inner surface 22al of the second base portion 22a. As shown in FIG. 4A, extremities 21b1 of the side leg portions 21b and extremities 22b1 of the side leg portions 22b abut each other and, as necessary, are joined using an adhesive.

As shown in FIG. 3A2, the location of a venting surface 82a of the heat-dissipating resin 82 is determined with respect to the location of the upper end 23b of the middle leg portion 23 so that an air layer is preferably provided in the space 38 between the upper end 23b of the middle leg portion 23 and the inner surface 22al of the second base portion 22a. The location of the venting surface 82a of the heat-dissipating resin 82 with which the case 8 is filled is determined in relation to the volume and the like of the middle leg portion 23 so that, for example, the heat-dissipating resin 82 does not enter at least a part of the space 38 and that the middle leg portion 23 is sufficiently cooled.

That is, the location of the venting surface 82a is determined so that 70% or more, preferably 80% or more, more preferably 90% or more, or still more preferably 95% or more of the volume of the middle leg portion 23 is located below the venting surface 82a of the heat-dissipating resin 82 and below the inner surface 22al of the second base portion 22a along the Z-axis. With such a structure, in the space 38, the air layer where the heat-dissipating resin 82 does not enter is provided.

The location of the venting surface 82a of the heat-dissipating resin 82 is determined so that the second wire winding portion 50 of the second wire 5 is sufficiently immersed in the heat-dissipating resin 82 and that preferably 80% or more, more preferably 95% or more, or substantially 100% or more of the first wire winding portion 40 of the first wire 4 is immersed in the heat-dissipating resin 82. With such a structure, heat generated at the winding portion 40 or 50 of the wire 4 or 5 is cooled by the heat-dissipating resin 82.

In the present embodiment, heat transferred from the winding portion 40 or 50 of the wire 4 or 5 or the core 2 to the heat-dissipating resin 82 is dissipated, via the case 8, to a cooling member (e.g., a cooling block having a cooling passage) installed under a lower surface of a bottom plate 80 of the case 8. Note that the venting surface 82a is a solidified liquid surface of the heat-dissipating resin 82 in a fluid state entering the case 8.

As shown in FIG. 1A, the case 8 includes the bottom plate 80 having a substantially rectangular shape and a side plate 81 extending upwards along the Z-axis from the four sides of the bottom plate 80 to provide a bottomed accommodation space. The top of the case 8 along the Z-axis is open. The case 8 is preferably made of metal with high thermal conductivity (e.g., aluminum) but may be made of resin.

The heat-dissipating resin 82 is also referred to as a potting resin and is constituted by, for example, silicone resin, urethane resin, or epoxy resin, which remain soft after injection. The potting resin has a modulus of longitudinal elasticity of preferably 0.1 to 100 MPa. In the present embodiment, heat generated at the first wire winding portion 40, the second wire winding portion 50, and the core 2 is efficiently dissipated outside from the bottom of the case 8 via, for example, the heat-dissipating resin 82 and the case 8 to allow increase in cooling efficiency of the coil device 1.

The bobbin 3 (with the wires) having the core 2 shown in FIG. 2A attached may be accommodated in the case 8 after the case 8 is filled with the heat-dissipating resin 82 in advance; or the case 8 may be filled with the heat-dissipating resin 82 after the bobbin 3 (with the wires) having the core 2 attached is accommodated in the case 8.

In the coil device 1 according to the present embodiment, because most of the volume of the middle leg portion 23 of the core 2 is located below the venting surface 82a of the heat-dissipating resin 82 as shown in FIGS. 3A1 and 3A2, most of the volumes of the winding portions 40 and 50, disposed around the middle leg portion 23, of the wires 4 and 5 as well as the middle leg portion 23 is cooled by the heat-dissipating resin 82. This improves heat-dissipating ability.

Moreover, because the air layer constituting the space 37 is provided between the first base portion 21a and one end (the lower end 23a) of the middle leg portion 23, heat of the middle leg portion 23 is less readily transferred to the first base portion 21a, reducing variance in temperature distribution of the middle leg portion 23 along the winding axis. The middle leg portion 23 is evenly cooled by the heat-dissipating resin.

Consequently, at the middle leg portion 23, a rapid temperature gradient is less readily generated along the winding axis (parallel to the Z-axis) of the wire 4 or 5; and thermal stress generated at the core 2 (in particular, the middle leg portion 23) is reduced. This reduces core losses.

Around the circumference of the lower end 23a of the middle leg portion 23, the O-ring 6 as a sealing member is attached; and the O-ring 6 solely or a combination of the O-ring 6 and the spacer 7 provides the air layer (space 37) having the predetermined distance between the first base portion 21a and the lower end 23a of the middle leg portion 23. Such a structure effectively prevents the heat-dissipating resin 82 in a fluid state around the O-ring 6 (or the O-ring 6 and the spacer 7) from entering the space 37 (air layer), maintaining the air layer having the predetermined thickness.

In a situation where the sealing member (e.g., the O-ring 6 and the spacer 7) is used, the heat-dissipating resin may slightly enter a part of the space 37. Also, in the space between the first base portion 21a and the lower end 23a of the middle leg portion 23, a resin layer other than the air layer may be provided. However, the area of the air layer constituting the space 37 (area perpendicular to the winding axis) is preferably 50% or more of the area of the lower end 23a of the middle leg portion 23 and is more preferably larger like 60% or more, 70% or more, 80% or more, 90% or more, 98% or more, 99% or more, or 100% or more of the area of the lower end 23a.

In a situation where the sealing member (e.g., the O-ring 6 and the spacer 7) is used, an upper limit of the thickness t1 (see FIG. 4A) of the air layer in the space 37 along the winding axis (parallel to the Z-axis) is not limited and is determined according to leakage properties or the like required for a coil device. The upper limit is preferably 3 mm or less, more preferably 2 mm or less, or still more preferably 1 mm or less. A lower limit of the thickness t1 of the air layer along the winding axis is determined so that the amount of heat transfer from the lower end of the middle leg portion 23 to the surface of the first base portion 21a is smaller than the amount in a situation where no air layer is provided. The lower limit is preferably, for example, 5 μm or more, 8 μm or more, 10 μm or more, or 12 μm or more.

In the present embodiment, the core 2 may further include a second base portion 22a that is provided continuously at the other end (upper end 23b) of the middle leg portion 23 along the winding axis; however, the core 2 of the present embodiment further includes the second base portion 22a disposed apart by the predetermined distance t2 from the other end (upper end 23b) of the middle leg portion 23 along the winding axis.

In the present embodiment, between the inner surface 22al of the second base portion 22a and the upper end 23b of the middle leg portion 23 is the space 38 constituting the air layer having a thickness of preferably 3 mm or less, more preferably 2 mm or less, or still more preferably 1.9 mm or less. This air layer between the second base portion 22a and the upper end 23b of the middle leg portion 23 makes it difficult for stress (e.g., thermal expansion force) generated at the middle leg portion 23 to be transferred to the second base portion 22a, allowing reduction of thermal stress that may be generated at the second base portion 22a. Consequently, possibility of trouble (e.g., cracks or chips of the core) can be reduced.

In the present embodiment, 30% or more, 50% or more, 80% or more, 95% or more, or preferably 100% or more of the volume of the second base portion 22a is exposed from the heat-dissipating resin 82. With most of the second base portion 22a being exposed, the case 8 accommodating the heat-dissipating resin 82 can be reduced in size, and the amount of the heat-dissipating resin 82 can be reduced. Moreover, in this situation as well, because the second base portion 22a is disposed apart by the predetermined distance of the space 38 from the upper end of the middle leg portion 23 along the Z-axis, stress (e.g., thermal expansion force) generated at the middle leg portion 23 where heat is readily built up is not transferred to the second base portion 22a. Thus, excessive thermal stress that may be generated at the second base portion 22a can be reduced.

In the present embodiment, the first base portion 21a is close to the bottom plate 80, which is a cooling wall surface of the case 8 filled with the heat-dissipating resin 82. In a situation where the cooling wall surface of the case 8 is a bottom surface of the case 8, the core 2 is preferably accommodated in the case 8 so that the winding axes of the winding portions 40 and 50 of the wires 4 and 5 are substantially perpendicular to the bottom surface of the case 8.

In a situation where the cooling wall surface of the case 8 is a side surface (side plate 81) of the case 8 in another embodiment, the core 2 may be accommodated in the case 8 so that the winding axes of the winding portions 40 and 50 of the wires 4 and 5 are substantially parallel to the bottom surface of the case 8. In either situation, particularly the first base portion 21a is cooled to readily produce temperature difference; however, because the space 37 constituting the air layer is provided between the one end (lower end 23a) of the middle leg portion 23 and the first base portion 21a, unevenness of temperature distribution of the middle leg portion 23 along the winding axes can be improved.

In the present embodiment, the upper end 23b of the middle leg portion 23 may be located below the venting surface 82a of the heat-dissipating resin 82. With such a structure, heat-dissipation ability of the middle leg portion 23 and the winding portions 40 and 50, disposed therearound, of the wires 4 and 5 is improved. In this situation as well, the venting surface 82a is preferably located partway in the space 38 so that the space 38 has the air layer. Also, the upper end 23b of the middle leg portion 23 may be located above the venting surface 82a of the heat-dissipating resin 82. With such a structure, the space 38 constituting the air layer is readily provided between the second base portion 22a and the upper end 23b of the middle leg portion 23.

The venting surface 82a of the heat-dissipating resin 82 is located at a location such that the heat-dissipating resin 82 covers the winding portions 40 and 50, disposed around the middle leg portion 23, of the wires 4 and 5. With such a structure, heat-dissipation ability of the winding portions 40 and 50 is improved.

### Second Embodiment

As shown in FIGS. 1B, 2B, 3B1, and 3B2, a coil device 1A of the present embodiment is similar to the coil device 1 of the aforementioned embodiment unless otherwise described below and exhibits similar effects. That is, in the present embodiment, as shown particularly in FIG. 3B2, a tubular portion 30 of a bobbin 3 is disposed between a middle leg portion 23 and winding portions 40 and 50 of wires 4 and 5.

The tubular portion 30 of the bobbin 3 is provided with, partway along the Z-axis, a main partitioning flange 31 for insulating a primary side coil against a secondary side coil so that the main partitioning flange 31 protrudes in a radial direction from an outer circumferential surface of the tubular portion 30. The tubular portion 30 is provided with, below the main partitioning flange 31 along the Z-axis, sub-partitioning flanges 32 at predetermined intervals along the Z-axis so that the sub-partitioning flanges 32 protrude in the radial direction from the outer circumferential surface of the tubular portion 30. In a compartment between the main partitioning flange 31 and one of the sub-partitioning flanges 32 and compartments between the sub-partitioning flanges 32, the first wire 4 is wound to form the first wire winding portion 40.

Similarly, the tubular portion 30 is provided with, above the main partitioning flange 31 along the Z-axis, sub-partitioning flanges 32 at predetermined intervals along the Z-axis so that the sub-partitioning flanges 32 protrude in the radial direction from the outer circumferential surface of the tubular portion 30. In a compartment between the main partitioning flange 31 and one of the sub-partitioning flanges 32 and compartments between the sub-partitioning flanges 32, the second wire 5 is wound to form the second wire winding portion 50.

The compartments between the main partitioning flange 31 and the sub-partitioning flanges 32 along the Z-axis and the compartments between the sub-partitioning flanges 32 have a size slightly larger than an external diameter of the first wire 4 or the second wire 5; and only one row of the wire 4 or 5 can enter each of these compartments along the Z-axis. Thus, the wire 4 or 5 can be orderly wound around the outer circumferential surface of the tubular portion 30 of the bobbin 3.

At least at one point of each sub-partitioning flange 32 along its circumferential direction, the sub-partitioning flange 32 has a notch extending in the radial direction from a circumferential point of the sub-partitioning flange 32 to a circumferential point of the tubular portion 30. Via this notch, the wire 4 or 5 can be moved along the Z-axis between the adjacent compartments; and the wire 4 or 5 can be continuously wound around. How the wire 4 or 5 is wound is not limited; and it may be, for example, normally wound or a-wound.

The second wire winding portion 50 is disposed above the first wire winding portion 40 along the Z-axis; however, they may be disposed vice versa. In the present embodiment, for example, the first wire winding portion 40 is the primary side coil of the transformer, and the second wire winding portion 50 is the secondary side coil of the transformer; however, they may be vice versa. The first wire winding portion 40 and the second wire winding portion 50 are separated by the main partitioning flange 31 in the Z-axis direction, and their coupling coefficient and the like are adjusted.

As shown in FIG. 3B2, at an inner circumferential surface of the sub-partitioning flange 32 at a lower end of the tubular portion 30 of the bobbin 3 along the Z-axis, an inward protrusion 36 protruding inwards from an inner circumferential surface of the tubular portion 30 is provided continuously along its circumferential direction. The inward protrusion 36 protrudes from the inner circumferential surface of the tubular portion 30 to the extent that the inward protrusion 36 does not cover a lower end of a through-hole defined by the inner circumferential surface of the tubular portion 30 along the Z-axis. The inward protrusion 36 tightly abuts an O-ring 6 attached to a circumferential portion of a lower end 23a of the middle leg portion 23 along the Z-axis. Consequently, a space 37 is provided between the lower end 23a of the middle leg portion 23 along the Z-axis and an inner surface 21al of a first base portion 21a.

A lower surface of the inward protrusion 36 having a ring shape is adhered to the inner surface 21al of the first base portion 21a, and the O-ring 6 seals a space between the lower end 23a of the middle leg portion 23 and the inward protrusion 36, so that a heat-dissipating resin 82 does not enter the space 37. The space 37 has an air layer having a predetermined thickness where the heat-dissipating resin 82 does not enter. The distance (thickness) of the space 37 can be adjusted by changing a design thickness of the inward protrusion 36 along the Z-axis.

As shown in FIG. 2B, core guide walls 34 are provided at both sides in the X-axis direction of the sub-partitioning flange 32 at an upper end of the tubular portion 30 of the bobbin 3 along the Z-axis. Core guide walls 35 are provided at both sides in the X-axis direction of the sub-partitioning flange 32 at the lower end of the tubular portion 30 of the bobbin 3 along the Z-axis. Against an outer surface (a lower surface 32b) of the sub-partitioning flange 32 between the core guide walls 35, the first base portion 21a of a first core 21 is placed. Side leg portions 21b of the first core 21 cover, along the Z-axis, a lower portion of the bobbin 3 at both sides in the Y-axis direction.

In the through-hole defined by the inner circumferential surface of the tubular portion 30 of the bobbin 3, the middle leg portion 23 having the O-ring 6 as a sealing member attached around the lower end is inserted from above in the Z-axis direction. As shown in FIG. 3B2, the O-ring 6 abuts the inward protrusion 36 provided at the inner circumferential surface of the lower end of the tubular portion 30 of the bobbin 3 to hold the lower end 23a of the middle leg portion 23 away from the inner surface 21al of the first core 21 by a predetermined distance of the space 37.

The core 2 is then attached to the bobbin 3 so that a second base portion 22a of a second core 22 is located between the core guide walls 34. Consequently, against an outer surface (upper surface 32a) of the sub-partitioning flange 32 between the core guide walls 34, the second base portion 22a of the second core 22 is placed. Side leg portions 22b of the second core 22 cover, along the Z-axis, an upper portion of the bobbin 3 at both sides in the Y-axis direction. Extremities 22b1 of the side leg portions 22b and extremities 21b1 of the side leg portions 21b of the first core 21 abut each other and, as necessary, are joined using an adhesive.

Similarly to the first embodiment, as shown in FIG. 4A, in the coil device 1A according to the present embodiment, the space 37 constituting the air layer having the predetermined distance t1 is provided; and, as necessary, a space 38 having a predetermined distance t2 can be provided. In the present embodiment, as shown in FIG. 3B2, a combination of the O-ring 6 and the inward protrusion 36 at the lower end of the tubular portion 30 of the bobbin 3 effectively prevents the heat-dissipating resin 82 in a fluid state from entering the space 37 constituting the air layer, allowing maintenance of the air layer having the predetermined thickness. Other structures and effects of the present embodiment are similar to those of the first embodiment.

### Third Embodiment

As shown in FIG. 4B, a coil device of the present embodiment is similar to the coil device 1 or 1A of the first or second embodiment unless otherwise described below and exhibits similar effects. That is, the coil device of the present embodiment has a similar structure except that the coil device includes a core 2A different from the core 2 of the aforementioned embodiments and exhibits similar effects.

The core 2A of the present embodiment is different from the core 2 of the aforementioned embodiments in that the core 2A includes a step-like protruding portion 24 at an inner surface of a first base portion 21a facing an upper end or a lower end of a middle leg portion 23 along the Z-axis. The step-like protruding portion 24 may have any protruding length (along the Z-axis) so long as a space 38 or 37 is provided between an extremity of the step-like protruding portion 24 along the Z-axis and the upper or lower end of the middle leg portion 23.

However, it is desirable that the protruding length of the step-like protruding portion 24 facing the upper end of the middle leg portion 23 be as small as possible. The protruding length of the step-like protruding portion 24 provided at the first base portion 21a is preferably about half the height of side leg portions 21b along the Z-axis at most, because the step-like protruding portion 24 turns out to function as the middle leg portion 23 when, in particular, having a high protruding length. Other structures and effects are similar to those of the aforementioned embodiments, and description of the similarities is omitted.

### Fourth Embodiment

As shown in FIG. 4C, a coil device of the present embodiment is similar to the coil devices of the first to third embodiments unless otherwise described below and exhibits similar effects. That is, the coil device of the present embodiment has a similar structure except that the coil device includes a core 2B different from the core 2 or the core 2A of the aforementioned embodiments and exhibits similar effects.

The core 2B of the present embodiment is different from the core 2 of the aforementioned embodiments in that a first core 21 includes a first base portion 21a independent from side leg portions 25 and that a second core 22 includes a second base portion 22a independent from the side leg portions 25. The side leg portions 25 have a structure in which the corresponding side leg portions 21b and 22b, which face each other along the Z-axis direction, of the aforementioned embodiments are integrated and are separated from the respective base portions 21a and 22a. Other structures and effects are similar to those of the aforementioned embodiments, and description of the similarities is omitted.

### Fifth Embodiment

As shown in FIG. 4D, a coil device of the present embodiment is similar to the coil devices of the first to fourth embodiments unless otherwise described below and exhibits similar effects. That is, the coil device of the present embodiment has a similar structure except that the coil device includes a core 2C different from the core 2, 2A, or 2B of the aforementioned embodiments and exhibits similar effects.

The core 2C of the present embodiment is different from the core 2 of the aforementioned embodiments in that an upper end of a middle leg portion 23C is integrated with a second base portion 22a of a second core 22. Other structures and effects are similar to those of the aforementioned embodiments, and description of the similarities is omitted.

### Sixth Embodiment

As shown in FIG. 4E, a coil device of the present embodiment is similar to the coil devices of the first to fifth embodiments unless otherwise described below and exhibits similar effects. That is, the coil device of the present embodiment has a similar structure except that the coil device includes a core 2D different from the core 2, 2A, 2B, or 2C of the aforementioned embodiments and exhibits similar effects.

The core 2D of the present embodiment is different from the core 2B of the aforementioned embodiment shown in FIG. 4C in that an upper end of a middle leg portion 23C is integrated with a second base portion 22a of a second core 22. Other structures and effects are similar to those of the aforementioned embodiments, and description of the similarities is omitted.

### Seventh Embodiment

Although illustrations of the drawings are omitted, in a coil device of the present embodiment, a lower end 23a of a middle leg portion is in contact with an inner surface 21al of a first base portion 21a of a first core 21, without the use of, for example, an O-ring 6 and/or a spacer 7 shown in FIG. 3A2. A surface of the lower end 23a of the middle leg portion or a surface (at least a surface corresponding to the lower end 23a) of the inner surface 21al of the first base portion 21a is roughened in advance to have fine irregularities. Examples of roughening treatments are not limited and include a mechanical roughening treatment, a physical roughening treatment, an electrochemical roughening treatment, and a chemical roughening treatment. Specifically, these examples include, for example, shotblasting, polishing, plasma processing, laser processing, and etching.

In a situation where the surface of the lower end 23a of the middle leg portion and the surface of the inner surface 21al of the first base portion 21a simply abut each other without the use of an adhesive or the like, a heat-dissipating resin 82 does not get in between the abutting surfaces, and a space in a depression corresponding to surface roughness of the fine irregularities becomes an air layer. The depth of the depression is equivalent to the thickness of the air layer (thickness in the direction parallel to a winding axis of a winding portion).

In this situation, a lower limit of the thickness of the air layer along the winding axis (depth of the depression) is determined depending on the surface roughness or the like of the fine irregularities and is not limited; and the lower limit is preferably, for example, 5 μm or more, 8 μm or more, 10 μm or more, or 12 μm or more. An upper limit of the thickness of the air layer along the winding axis is determined so that it is difficult for the heat-dissipating resin in a fluid state to get in between the first base portion 21a and the lower end 23a of the middle leg portion 23 abutting each other and is not limited; and the upper limit is preferably, for example, 50 μm or less, 40 μm or less, 30 μm or less, 20 μm or less, or 15 μm or less.

The depression of the fine irregularities providing the air layer may have any width; however, the width is preferably about a quarter of the depth of the depression to about four times the depth of the depression. Provided that the area where the lower end 23a of the middle leg portion and the inner surface 21al of the first base portion 21a abut (i.e., the area of the lower end 23a) is 100%, the area of the depression of the fine irregularities (the area of the air layer) is not limited and occupies preferably 20% to 90% or more preferably 30% to 80%. The depression may be provided continuously but may also be provided intermittently.

Provided that at least either the surface of the first base portion 21a or the surface of the lower end 23a of the middle leg portion 23 abutting each other has the fine irregularities, only placing the lower end 23a of the middle leg portion 23 on the inner surface 21al of the first base portion 21a can easily provide the air layer having the thickness within such a range. With the air layer having the thickness within such a range, it is difficult for the heat-dissipating resin in a fluid state to get in between the abutting surfaces of the first base portion 21a and the lower end 23a of the middle leg portion 23, and the air layer having the predetermined thickness is maintained. Note that the heat-dissipating resin 82 may slightly enter a part of the air layer.

The present invention is not limited to the above embodiments and can variously be modified within the scope of the present invention.

For example, while the core 2 includes a combination of three or four divisions of the core in the above embodiments, the number of divisions is not limited to these; and the core can include a combination of, for example, two divisions, five divisions, or other number of divisions.

While the Z-axis is substantially parallel to the winding axis of the wire winding portion 40 or 50 in the above embodiments, the wire winding portion 40 or 50 may be accommodated in the case 8 so that the winding axis is substantially parallel to the X-axis or the Y-axis. In such a situation as well, the space 37 constituting the air layer is preferably located below the venting surface 82a of the heat-dissipating resin 82 along the Z-axis.

### REFERENCE NUMERALS

1, 1A . . . coil device
2, 2A to 2D . . . core
21 . . . first core
21a . . . first base portion
21al . . . inner surface
21b . . . side leg portion
21b1 . . . extremity
22 . . . second core
22a . . . second base portion
22a1 . . . inner surface
22b . . . side leg portion
22b1 . . . extremity
23, 23C . . . middle leg portion
23a . . . lower end
23b . . . upper end
24 . . . step-like protruding portion
25 . . . side leg portion
3 . . . bobbin
30 . . . tubular portion
31 . . . main partitioning flange
32 . . . sub-partitioning flange
32a . . . upper surface
32b . . . lower surface
34, 35 . . . core guide wall
36 . . . inward protrusion
37, 38 . . . space (air layer)
4 . . . first wire
40 . . . first wire winding portion
41a, 41b . . . lead portion
5 . . . second wire
50 . . . second wire winding portion
51a, 51b . . . lead portion
6 . . . . O-ring (sealing member)
7 . . . spacer
8 . . . case
80 . . . bottom plate
81 . . . side plate
82 . . . heat-dissipating resin
82a . . . venting surface

What is claimed is:

1. A coil device comprising:
a core comprising a magnetic material; and
a wire disposed in a coil shape around at least a part of the core,
wherein
the core comprises a middle leg portion and a first base portion;
the middle leg portion has a winding portion of the wire disposed therearound;
the first base portion is disposed at or near one end of the middle leg portion along a winding axis of the winding portion;
70% or more of a volume of the middle leg portion is located below a venting surface of a heat-dissipating resin;
between the first base portion and the one end of the middle leg portion is an air layer; and
the air layer is located below the venting surface of the heat-dissipating resin.

2. The coil device according to claim 1, wherein
at least either a surface of the first base portion or a surface of the one end of the middle leg portion has fine irregularities at which the first base portion and the one end of the middle leg portion are partly in contact; and
the air layer is in a depression of the fine irregularities.

3. The coil device according to claim 2, wherein the air layer has a thickness of 5 μm or more and 50 μm or less along the winding axis.

4. The coil device according to claim 1, wherein
a sealing member is attached to a circumference of the one end of the middle leg portion; and
the sealing member solely or a combination of the sealing member and an other member provides the air layer having a predetermined distance between the first base portion and the one end of the middle leg portion, thereby preventing the heat-dissipating resin from entering the air layer.

5. The coil device according to claim 4, wherein
a tubular portion of a bobbin is disposed between the middle leg portion and the winding portion of the wire;
the other member comprises an inward protrusion at one end of the tubular portion of the bobbin; and
the sealing member is disposed between the inward protrusion and the one end of the middle leg portion.

6. The coil device according to claim 4, wherein
the sealing member comprises an O-ring;
the other member comprises a spacer having a ring shape and adhering to a surface of the first base portion; and
the O-ring is held around the circumference of the one end of the middle leg portion and is disposed on the spacer.

7. The coil device according to claim 1, wherein the air layer has a thickness of 5 μm or more and 3 mm or less along the winding axis.

8. The coil device according to claim 1, wherein the core further comprises a second base portion provided continuously at an other end of the middle leg portion along the winding axis.

9. The coil device according to claim 1, wherein the core further comprises a second base portion disposed apart by a predetermined distance from an other end of the middle leg portion along the winding axis.

10. The coil device according to claim 1, wherein the first base portion is close to a cooling wall surface of a case filled with the heat-dissipating resin.

11. The coil device according to claim 8, wherein the other end of the middle leg portion is located below the venting surface of the heat-dissipating resin.

12. The coil device according to claim 8, wherein the other end of the middle leg portion is located above the venting surface of the heat-dissipating resin.

13. The coil device according to claim 1, wherein the heat-dissipating resin is disposed at a location such that the heat-dissipating resin covers the winding portion disposed around the middle leg portion.

14. The coil device according to claim 1, further comprising a terminal block holding a lead portion of the wire.

15. The coil device according to claim 14, wherein the terminal block is attached to a bobbin, a case accommodating the heat-dissipating resin, or a second base portion disposed at or near an other end of the middle leg portion along the winding axis.
